(19) United States
(12) Patent Application Publication
(10) Pub. No.: US 2010/0161562 A1
(43) Pub. Date: Jun. 24, 2010

(54) Method and apparatus for preventing duplicate or redundant data from storing in media player

(76) Inventor: Sachin Karajagi, Torrance, CA (US)

Correspondence Address: MURAMATSU & ASSOCIATES, Suite 310, 114 Pacifica, Irvine, CA, 92618, US

(21) Appl. No.: 12/316,522

(22) Filed: Dec. 12, 2008

(51) Int. Cl. G06F 17/30; G06F 7/00

(52) U.S. Cl. 707/664

(57) ABSTRACT

A method and apparatus prevents duplicate and redundant data of song information from being stored in a media player by checking a category and duplication of meta data associated with a song that is received through digital broadcasting. The method and apparatus prevents the unwanted meta data, such as a station name, channel number, station frequency, specified in advance or other redundant data such as the one already stored in the media player from being stored in the media player. Thus, when listening a song from a digital radio broadcasting station, the method and apparatus enables to effectively collect the meta data in the media player that are necessary for later activities such as purchasing the music file of the song.

### FIELD OF THE INVENTION

This invention relates generally to a method and apparatus for storing song information in a media player, more particularly, to a method and apparatus for preventing duplicate and redundant data of song information from being stored in the media player by checking a category and duplication of meta data associated with a song that is received through digital broadcasting.

### BACKGROUND OF THE INVENTION

Portable audio/video players such as iPod, Zune, and Gigabeat are popular devices to listen to music as well as to watch visual images. Typically, these device store music and video files (hereafter “music file”) in such file formats as MP3, WAV, WMA, AAC, etc., which can be easily downloaded through wired or wireless network communication. A user creates a library of favorite music files in the portable audio/video player and listens to the music while working, studying, walking, or the like.

FIG. 1 is a schematic diagram showing a basic structure involved in a portable audio/video player (hereafter “media player”) for downloading and creating a library of music files in the media player. Typically, before using a media player 23, a user generally operates a computer 29 to transfer audio and/or video data from a remote service provider via internet (WEB) 21 to the media player 23. The computer 29 installs an application software such as “i-Tunes” to assist such operations thereby creating a play list (library) in the media player 23.

Alternatively, the user receives radio broadcasting signals from a remote radio station directly to the media player 23. When the user likes a song which is being broadcasted and wants to have a copy of the song, however, it is usually not allowed to directly copy the song to the media player 23 from the radio broadcasting if such a favorite song is a copyrighted work. Thus, it is necessary to purchase the music file of the favorite song through, for example, the setting of FIG. 1.

Due to the usefulness of these devices, many users may want to use the portable players to listen to their favorite music stored therein directly or through another audio/video players such as a one having a larger screen and speakers. For example, a user wants to enjoy the music stored in the portable player 23 in a vehicle with use of the vehicle's audio/video system 30 as shown in FIG. 2. In this example, an interface unit 27 is connected between the media player 23 and the vehicle audio/video player 30 to establish communication between the two by compensating the differences in data formats, etc.

The recent digital radio technology, such as HD (high definition) Radio, enables AM and FM radio stations to broadcast their programs digitally. These digital radio broadcasts can provide improved audio quality and reception because they use digital signals rather than analog signals. When broadcasting the digital signals, data services (meta data) such as song and artist information can also be sent along the music or sound. Such information as a song title and an artist name may be displayed on a display of the media player or other digital radio receiver so that a user can tell which song is being played on the radio.

The media player has a record button that is able to store the song information, such as a song title and an artist name, etc., for later use. When recording such song information, however, there arises a problem that the media player can also store duplicate or redundant information such as a station channel number, station frequency, etc. Such information is unnecessary for a normal user to use them later such as purchasing the song, etc. Thus, there is a need of a new method and apparatus which is able to prevent the redundant or duplicate song information from being recorded in the media player.

### SUMMARY OF THE INVENTION

It is, therefore, an object of the present invention to provide a method and apparatus for preventing the duplicate and redundant data of song information storing in the media player when receiving the song data.

It is another object of the present invention to provide a method and apparatus for preventing the duplicate and redundant data of song information from being stored in the media player when receiving the song and associated meta data through radio broadcasting or communication network.

It is a further object of the present invention to provide a method and apparatus for preventing the duplicate or redundant data of song information from being stored in the media player when receiving the song and associated meta data by checking a category of the meta data or any duplication of the meta data in the media player.

It is a further object of the present invention to provide a method and apparatus for storing only useful song information when listening to a song from a radio station and discards the duplicate or redundant meta data, thereby effectively purchasing the music file of the song based on the meta data stored in the media player.

One aspect of the present invention is a method of storing song information in a media player. The method includes the steps of: presetting a list of information in a memory in advance that indicates categories of song information that should be stored or not in a media player; checking whether a user activates a record button or equivalent thereof to instruct that song information of a song that is currently being played from a digital radio broadcasting station should be stored in the media player; retrieving the song information that is a group of information of the song that has been played at the timing of the user's instruction; comparing a category of the song information retrieved with the preset category of song information stored in the memory, thereby determining whether particular song information is necessary; and storing only the song information that is determined to be necessary in the media player while deleting the remaining song information.

In the method of the present invention, the song information is expressed by meta data which is digital data attached to digital data expressing the song currently broadcasted from the digital radio broadcasting station for explaining the information related to the song. The activation of the record button or equivalent thereof is made when the user is listening a song through the digital radio broadcasting to obtain the song information concerning the song.

The method of the present invention further includes the steps of: comparing the song information retrieved upon the instruction by the user with song information already stored in the media player; determining a duplication condition in a case where the both song information are identical to one another; and deleting either one of the song information when there is the duplication condition. The step of deleting either one of the song information includes a step of discarding the song information newly retrieved in response to the activation of the record button rather than that already stored in the media player.

In the method of the present invention, the step of presetting the list of information indicating the categories of song information includes a step of specifying an announcement or a time space contained in the meta data of the song as an unnecessary category of meta data. The method further includes a step of selecting the meta data of a first song rather than a second song when the activation of the record button or equivalent thereof is made at a timing of broadcasting transition from the first song to the second song.

The method of the present invention further includes a step of connecting the media player to a network to reach a service provider and sending the meta data of the song to the service provider to download the song data via the network. The method of the present invention further includes the steps of: connecting the media player to a computer and sending the meta data to the computer; connecting the computer to a network to reach a service provider and sending the meta data of the song to the service provider to download the song data via the network; and sending the downloaded song data from the computer to the media player.

In the method of the present invention, the song and meta data via the digital radio broadcasting are received by the media player or a receiver installed in a vehicle where an interface device for conducting each of the above defined steps is connected to the media player.

Another aspect of the present invention is an apparatus for storing the song information (meta data) in the media player. The apparatus of the present invention is configured by components corresponding to the various steps defined in the method invention noted above. The apparatus of the present invention effectively prevents the unwanted meta data, such as a station name, a channel number, a station frequency, or other redundant or duplicate data such as the one already stored in the media player from being stored in the media player.

According to the present invention, the method and apparatus is designed to easily record only a wanted part of meta data (song information) while avoiding an unwanted part of the meta data. The method and apparatus of the present invention effectively prevents the unwanted meta data, such as the station name, channel number, station frequency, or other redundant or duplicate data such as the one already stored in the media player from being stored in the media player. The method and apparatus checks the category of the meta data or reads the meta data already stored in the media player and discards the meta data that is in the specified category or the meta data that is already stored in the media player. Thus, when listening a song from a radio station, the method and apparatus of the present invention enables to effectively collect the meta data in the media player that are necessary for later activities such as purchasing the music file of the song.

### BRIEF DESCRIPTION OF THE DRAWINGS

FIG. 1 is a schematic diagram showing the relationship among a computer, a media player for downloading audio/video files from a remote server and creating a library of music, etc. in the media player.

FIG. 2 is a schematic diagram showing an example of manner of using the media player where it is used in a vehicle by connecting the portable player with a vehicle audio/video player through an interface unit.

FIG. 3A is a schematic view showing an example of manner of using meta data retrieved from a digital radio to download a favorite song through a personal computer and internet, and FIG. 3B is a schematic diagram showing an example of structure of the present invention for preventing from storing duplicate or redundant data of song information in the media player.

FIG. 4 is a schematic diagram showing a situation where radio signals from a radio broadcasting system are received by radio receivers in the form of a media player or a radio receiver of a vehicle.

FIG. 5 is a data table showing an example of meta data associated with each song for sending and receiving the song data between the service provider and the user through digital radio broadcast or internet.

FIGS. 6A and 6B are schematic diagrams showing special situations and timings for recording the song information, FIG. 6A shows a case where the meta data include an ambiguous part that is typically an announcement time or time space, and FIG. 6B shows a case where the record button is pressed at the timing of transition from one song to next song.

FIG. 7 is a flow chart describing an example of operational steps of the present invention to avoid storing duplicate song information in the media player in accordance with the present invention.

FIG. 8 is a flow chart describing an example of operational steps of the present invention for filtering the meta data to avoid storing the redundant category of song information in the media player.

FIG. 9 is a schematic diagram showing the components and functional block of the interface device of FIG. 3B for implementing the present invention for preventing the duplicated and redundant data from being recorded.

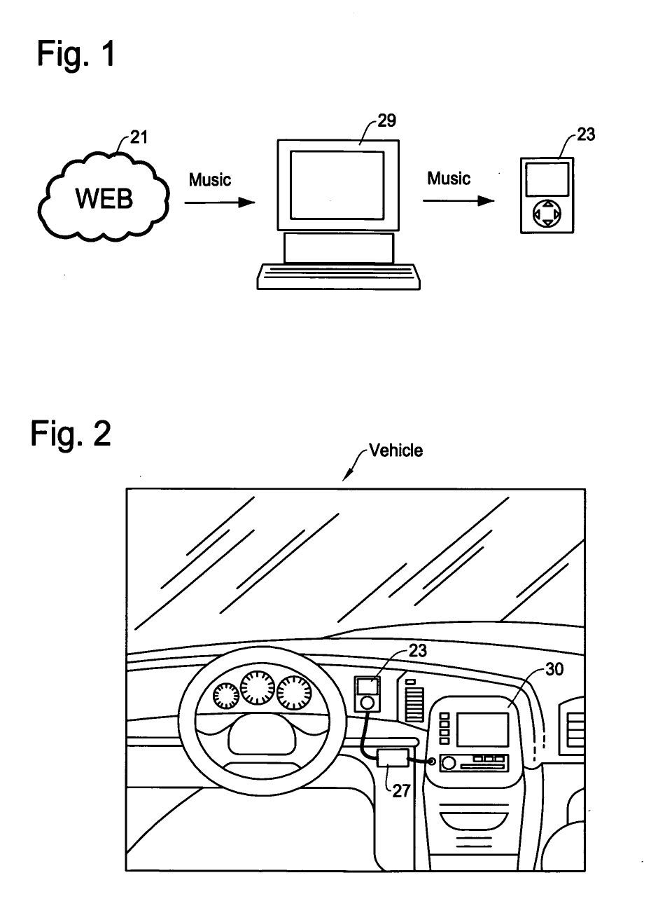

### DETAILED DESCRIPTION OF THE PREFERRED EMBODIMENT

The present invention will be described in detail with reference to the accompanying drawings. The method and apparatus of the present invention is designed to easily record only the wanted part of meta data (song information) while avoiding an unwanted part of meta data. Typically, the meta data is digital data attached to the song data currently broadcasted via digital radio broadcasting for explaining the information related to the song.

The method and apparatus of the present invention effectively prevents the unwanted meta data, such as a station name, a channel number, a station frequency, or other redundant or duplicate data such as the one already stored in the media player from recording in the media player. In the present invention, when recording the song information which is typically called “meta data” that are associated with a particular song or music in a media player, etc., it is able to filter out the specified type of song information so that such information will not be recorded in the media player.

As noted above, the song information is typically called “meta data” which is digital data for explaining the main data, i.e., the song data. Namely, the meta data consist of information that characterizes the main data (ex. song) such as a song title, a name of musician, an album name, etc. It should be noted that although such unwanted data is explained as a part of meta data of digital audio data for an illustration purpose, such unwanted data is not necessarily limited to the meta data, but can be commercial data, ambiguous data unrelated to a song, a time space between two or more songs, etc.

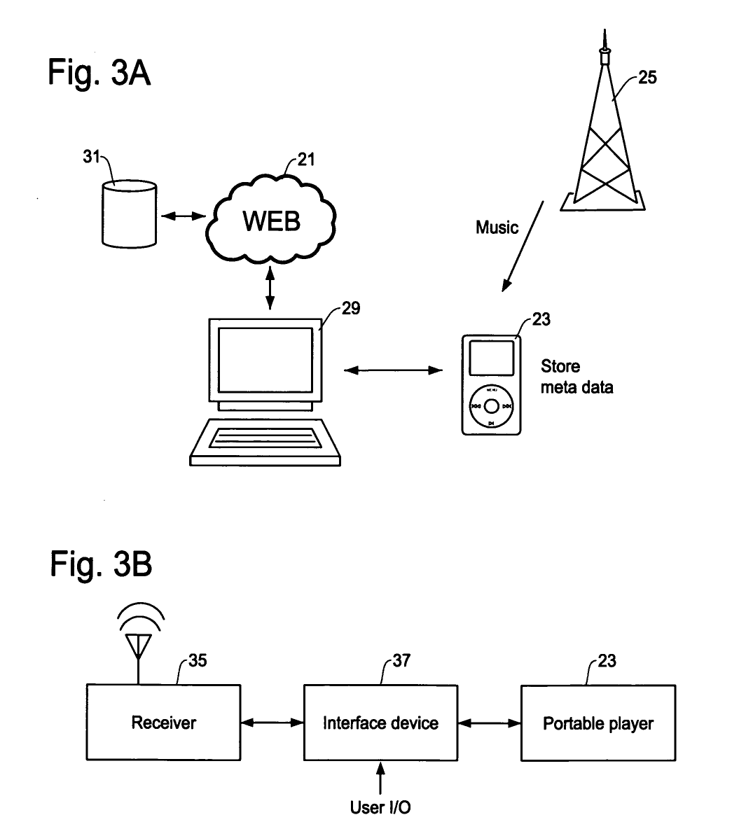

Referring to FIG. 3A, description is made regarding a basic concept and usage of meta data included in the digital audio signal received from a digital radio station or through a communication network such as internet. In the present invention, it is assumed that a user listens to the digital radio broadcasting from a radio station 25 and finds a favorite song that the user desires to purchase. It is also assumed that the user cannot directly record the song data from the radio signals, except for meta data associated with the song data, into his/her portable player because of copyright protection of the song, etc.

In such a situation, the user stores the meta data in the media player 23 by pressing, for example, a record (tag) button. The meta data stored in this manner can be used in several ways. For example, the user connects the media player 23 to a personal computer 29 to transfer the meta data to the personal computer 29. Further, the user connects the personal computer 29 to a service provider 31 through a communication network such as internet (WEB) 21.

In this set-up, the user is able to select the meta data to identify the favorite song such as a song title, artist information by means of the artist name, album title, etc., on the personal computer 29. Then, the user sends the selected meta data to the service provider 31 to purchase or otherwise download the favorite song specified by the meta data. The purchased song stored in the personal computer 29 may be converted to a compressed format such as MP3 and sent to the media player 23. Alternatively, the media player 23 may have its own internet accessibility that can directly connect to the internet to reach the service provider 31 without involving the personal computer 29.

FIG. 3B is an abstract view showing an example of structure of the apparatus of the present invention which is capable of preventing from storing the duplicate and redundant meta data or song information in the media player. In this example, a media player 23 is connected to an interface device 37 to exchange information in a digital form. As shown, the interface device 37 is an intermediary between the media player 23 and a receiver 35.

The receiver 35 may be a vehicle head unit having a radio tuner for selecting a radio channel among many radio station channels and producing an intermediary frequency signal containing the audio signals. The receiver 35 and the interface 37 are connected with one another and can exchange information in a digital or analog form. In this configuration, the receiver (head unit) 35 is able to play a song received from the radio station and to send the meta data related to the song to the media player 23 via the interface device 37.

The interface device 37 plays a major role of the present invention for preventing from storing the duplicated data or redundant data in the media player 23. The interface device 37 has a user I/O through which it receives user's selection indicating what category of meta data related to a song be removed from storing in the media player 23 because such data is redundant. Thus, when receiving the song information from the receiver 35, and also receiving a record instruction by the user through the user I/O (ex. record button), the interface device 37 compares the category of meta data of the song with that specified by the user and prevents the specified category of meta data from transmitting to the portable player 23.

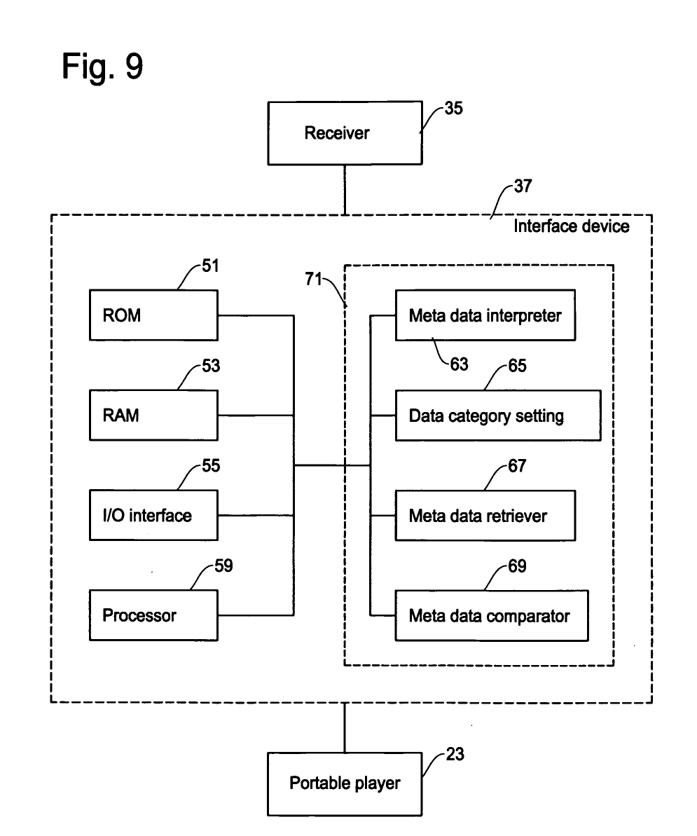

The interface device 37 further reads the meta data of the song that have already been stored in the media player 23 and compares the meta data received from the receiver 35. Thus, if the interface device 37 determines that the same meta data (song information) is already stored in the media player 23, it prevents such meta data from sending to the media player 23. The more details of the structure and operation of the interface device 37 will be described later with reference to FIG. 9.

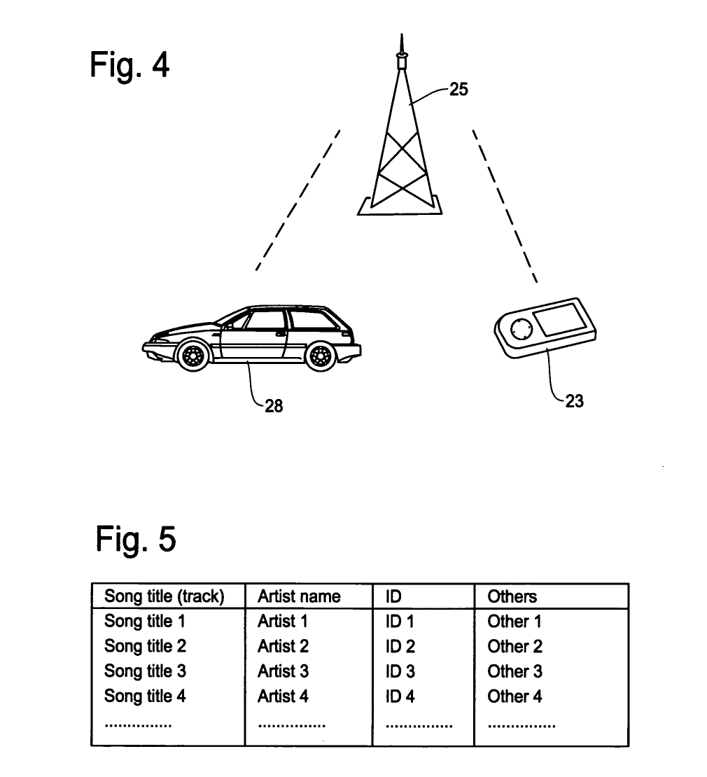

FIG. 4 is a schematic diagram showing a situation where radio signals from a radio broadcasting station are received by radio receivers in the form of a portable media player or a radio receiver of a vehicle. A head unit of a vehicle 28 and a media player 23 are capable of receiving the digital radio signals from a radio broadcasting station 25. In the case of the vehicle 28, an audio/video head unit can be the receiver 35 which will be connected to the interface device 37 as shown in FIG. 3B. The media player 23 may be a portable digital music player, a personal digital assistance (PDA) device, a cellular phone, a portable navigation device, etc.

The digital radio signal from the radio broadcasting station 25 includes audio (song) data as well as tag data (meta data) explaining the song data such as a song title, an artist name, etc. As to the radio broadcasting, such radio services as HD Radio, satellite radio such as Sirius and XM Radio are currently available. In the HD Radio system, digital information is transmitted using COFDM (orthogonal frequency-division multiplexing) with an audio compression algorithm called HDC (HD radio coding).

FIG. 5 is a data table showing an example of categories of the meta data associated with each song for sending and receiving the song data through digital radio broadcast or a communication network such as internet. As shown, a song title, an artist name, a song ID, and other information are listed for each song. The song ID is a unique identification word or number that can be used to retrieve a particular song (music file) from the service provider for purchasing.

Moreover, although not listed in the table in FIG. 5, a radio station name, a station frequency, a radio station ID, an affiliate ID, a date/time of receiving the song, etc., may also be included in the meta data. As noted above, not all of the meta data are necessary for actual use such as purchasing a music file for the media player 23. For example, a typical user of the media player 23 does not need to know the station name, station ID, or station frequency related to a particular song that has been broadcasted. Thus, the present invention prevents such unwanted data from being stored in the media player.

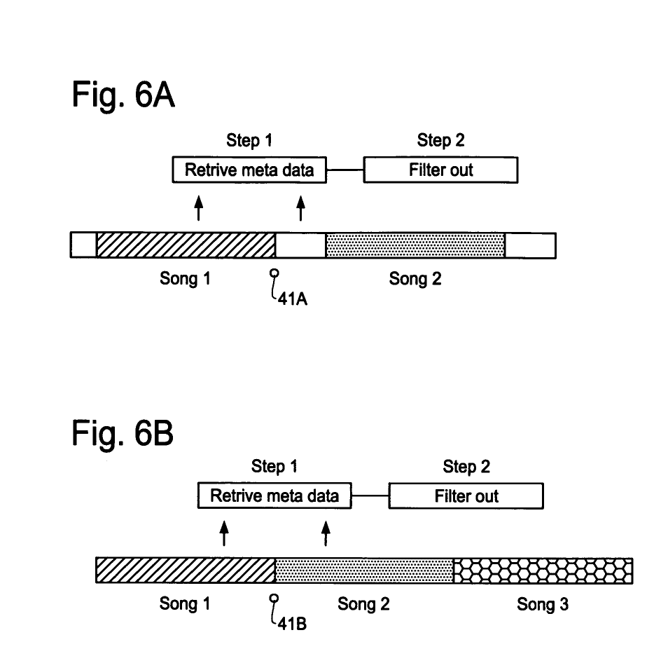

FIGS. 6A and 6B are schematic views showing the relationship between the timing of record instruction by a user and the meta data attached to the signals received from the radio station, etc. The hatched portion indicates that this part is the meta data of the corresponding song such as a song 1, a song 2, etc. while the non-hatched portion in FIG. 6A indicates an ambiguous part that is typically an announcement time, or simply a time space. The meta data in the hatched areas include various types of data as described with reference to FIG. 5 some of which may be redundant for the user to be stored in the media player 23.

FIG. 6A shows a case where redundant and ambiguous meta data or tags are included in the received signals and the record button (tag button) is pressed at the timing of 41A. When the user presses the record button at the timing point 41A, then both the information for the song 1 and the announcement or the space that is between the song 1 and the song 2 may be retrieved. In most cases, only the song information is required while the announcement or space is not desired. In this case, the system of the present invention such as the interface device 37 in FIG. 3B filters out the meta data corresponding to the announcement and space between the songs 1 and 2 as well as other redundant meta data in the hatched areas if such redundant data exist in the hatched areas.

FIG. 6B shows a case where the record instruction is made at the timing of 41B at which the song 1 is switched to the song 2, i.e., at the middle of the two songs. In this case, the meta data associated with both the song 1 and the song 2 may be retrieved. However, the method of the present invention assumes that the user is intended to copy the meta data of the song 1 rather than the song 2 and disregards the meta data for the song 2. This assumption is made because the user did not have time to listen to the song 2, thus, it is unlikely that the user needs the meta data of song 2. Such distinction of which meta data should be filter out is made in the predefined setting such as a data category setting 65 shown in FIG. 9.

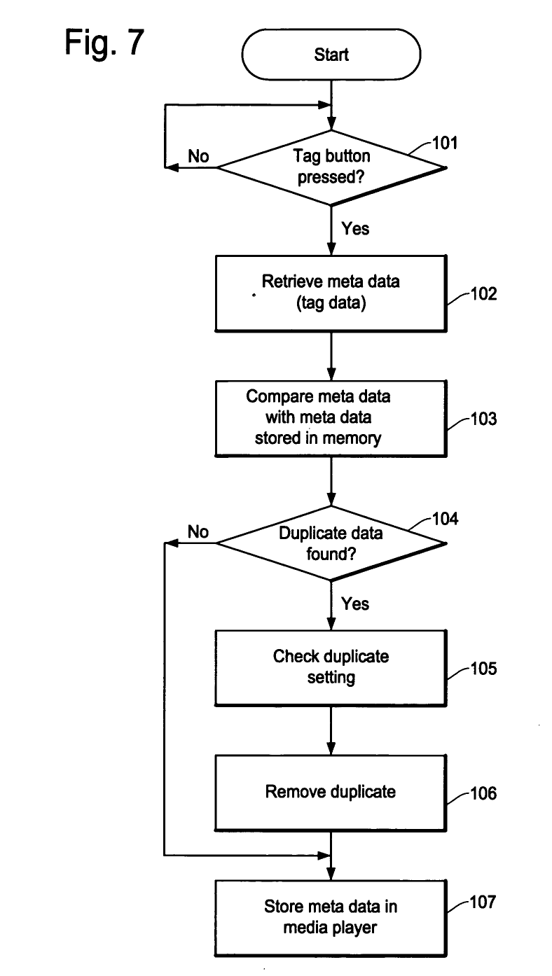

FIG. 7 is a flow chart describing an example of operational steps of the present invention to avoid storing duplicate song information in the media player in accordance with the present invention. As the procedure starts, in the first step 101, the process checks whether the user has pressed a record (tag) button to store the information of the song that is currently played. For example, the user provides such an instruction through the record button (user I/O) of the interface device 37 of FIG. 3B where the interface device 37 constantly checks whether there is any such an instruction.

If there is no instruction by the user to record the song information, the method waits until there is such an instruction by the user. If it is determined that the record button is pressed so that the song information (meta data) is to be stored, the method proceeds to the step 102 where the song information is retrieved. The song information or meta data is a group of information that is related to the song that has been played at the timing of the user's instruction (pressing the record button). Such song information include a song name, an artist name, etc, as shown in the meta data example in FIG. 5.

In the next step 103, the system will compare the song information with the song information already stored in a memory of the media player 23. In the step 104, the method of the present invention makes the determination as to whether the duplicate meta data have been found. In order to avoid incorrect determination that can be caused by checking only one data category, a plurality of data categories may be used to determine whether the same meta data are already stored in the media player 23.

For example, the song tile, artist name, and album name can be used as major categories of meta data to detect the duplicate condition. The present invention determines that only when all of the major data categories match with one another, the meta data is judged to be identical to the meta data that have been already stored. When the duplicate condition is not found, the process moves to the step 107 to store the meta data in the media player.

When the duplicate condition is found, the method moves to the step 105 to check the setting that predefines the next action to be taken such as to discard the meta data, display a warning message regarding the duplicate condition, prompt user's input, etc. If the predefined action is to discard the duplicated meta data, the present invention will delete the duplicate meta data in the step 106. In determining which of the duplicated meta data, between the meta data that had already been stored (old meta data) and the current meta data (new meta data), the present invention preferably discard the current meta data since this is done without need of an action for replacing the old meta data with new one. However, it is also possible that the present invention may discard the old meta data and store the new meta data instead.

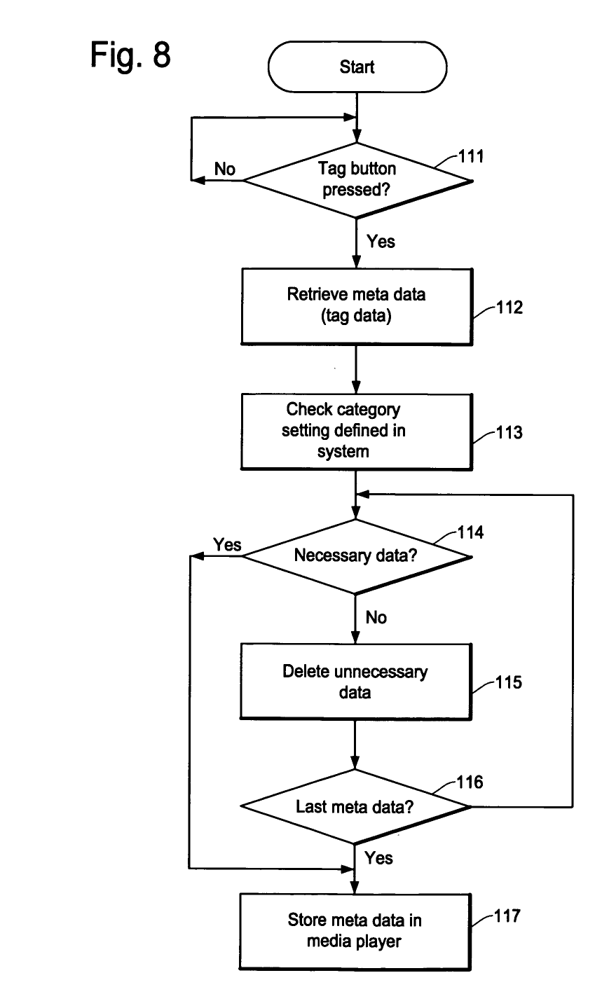

FIG. 8 is a flow chart describing an example of operational steps of the present invention for filtering the meta data to avoid storing the redundant data or duplicate data in the media player. In the step 111, the process checks whether the user has pressed a record (tag) button to store the information of the song that is currently played. If it is determined that the record button is pressed so that the song information (meta data) is to be stored, the process moves to the step 112 where the song information is retrieved. As noted above, such song information include a song name, an artist name, etc, as shown in the meta data example in FIG. 5.

Then, the present invention will check the data category setting prestored in the system (ex. interface device 37 in FIG. 3B) in the step 113. The data category setting defines which category of meta data is to be retained and which category of meta data is to be discarded for the purpose of storing them in the media player. In the step 114, the method will determine whether the category of meta data retrieved is defined as necessary data in the pre-setting. For instance, the data category setting shows that the title of song, song ID, and artist name are necessary while other information such as a station ID, channel number, date/time are unnecessary.

If it is determined that the particular meta data is necessary, the process moves to the step 117 to store the meta data in the media player. In contrast, if the particular meta data category is determined to be unnecessary, such meta data is deleted in the step 115. This procedure is repeated for each category of meta data until the last meta data as indicated by the step 116 which determines whether it is the last meta data. If the current meta data is the last meta data, the process ends

FIG. 9 is a functional block diagram showing an example of structure and components of the interface device 37 of the present invention for preventing from storing duplicate or redundant data of song information in the media player. In other words, this block diagram corresponds to the structure and function shown in the block diagram of FIG. 3B except that FIG. 9 shows more details of the interface device 37. The interface device 37 is typically connected between the receiver 35 such as a head unit of a vehicle and the portable media player 23 such as an iPod, Zoon, and the like.

The interface device 37 includes a ROM 51 which stores a program to carry out the operation of the interface device 37 which is described above with reference to flow charts of FIGS. 7 and 8, a processor 59 to control an overall operation of the interface device 37 by executing the program stored in the ROM 51, a RAM 53 for storing data other than the program to function as a primary workplace of the processor 59, an I/O interface 55 which allows the user to specify the category of meta data that should be saved or deleted, to start record (record button), to interface with other device such as a monitor screen, etc., and a software set 71 that has software tools 63, 65, 67, and 69.

The interface device 37 performs the procedures described with respect to the flow charts shown in FIG. 7 and FIG. 8 under the control of the processor 59. In the software set 71, the meta data interpreter 63 interprets the meta data that is received by the receiver 35. The data category setting 65 defines the information necessary to determine which category of meta data, such as a song title, an artist name, a station name, etc., is necessary. The meta data retriever 67 retrieves the meta data that has been received by the receiver 35. The meta data comparator 69 compares the received meta data with that defined in the data category setting 65 or that already stored in the media player 23.

As has been described above, according to the present invention, the method and apparatus is designed to easily record only a wanted part of meta data (song information) while avoiding an unwanted part of the meta data. The method and apparatus of the present invention effectively prevents the unwanted meta data, such as the station name, channel number, station frequency, or other redundant or duplicate data such as the one already stored in the media player from being stored in the media player. The method and apparatus checks the category of the meta data or reads the meta data already stored in the media player and discards the meta data that is in the specified category or the meta data that is already stored in the media player. Thus, when listening a song from a radio station, the method and apparatus of the present invention enables to effectively collect the meta data in the media player that are necessary for later activities such as purchasing the music file of the song.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A method of storing song information in a media player, comprising the following steps of:
presetting a list of information in a memory in advance that indicates categories of song information that should be stored or not in a media player;
checking whether a user activates a record button or equivalent thereof to instruct that song information of a song that is currently being played from a digital radio broadcasting station should be stored in the media player;
retrieving the song information that is a group of information of the song that has been played at the timing of the user's instruction;
comparing a category of the song information retrieved with the preset category of song information stored in the memory, thereby determining whether particular song information is necessary; and
storing only the song information that is determined to be necessary in the media player while deleting the remaining song information.

2. A method of storing song information in a media player as defined in claim 1, wherein said song information is expressed by meta data which is digital data attached to digital data expressing the song currently broadcasted from the digital radio broadcasting station for explaining the information related to the song.

3. A method of storing song information in a media player as defined in claim 1, wherein said activation of the record button or equivalent thereof is made when the user is listening a song through the digital radio broadcasting to obtain the song information concerning the song.

4. A method of storing song information in a media player as defined in claim 1, further comprising the following steps of:
comparing the song information retrieved upon the instruction by the user with song information already stored in the media player;
determining a duplication condition in a case where the both song information are identical to one another; and
deleting either one of the song information when there is the duplication condition.

5. A method of storing song information in a media player as defined in claim 1, wherein said step of deleting either one of the song information includes a step of discarding the song information newly retrieved in response to the activation of the record button.

6. A method of storing song information in a media player as defined in claim 2, wherein said step of presetting the list of information indicating the categories of song information includes a step of specifying an announcement or a time space contained in the meta data of the song as an unnecessary category of meta data.

7. A method of storing song information in a media player as defined in claim 2, further comprising a step of selecting the meta data of a first song rather than a second song when the activation of the record button or equivalent thereof is made at a timing of broadcasting transition from the first song to the second song.

8. A method of storing song information in a media player as defined in claim 2, further comprising a step of connecting the media player to a network to reach a service provider and sending the meta data of the song to the service provider to download the song data via the network.

9. A method of storing song information in a media player as defined in claim 2, further comprising the following steps of:
connecting the media player to a computer and sending the meta data to the computer;
connecting the computer to a network to reach a service provider and sending the meta data of the song to the service provider to download the song data via the network; and
sending the downloaded song data from the computer to the media player.

10. A method of storing song information in a media player as defined in claim 2, wherein said song and meta data via the digital radio broadcasting are received by the media player or a receiver installed in a vehicle where an interface device for conducting each of the above defined steps is connected to the media player.

10. An apparatus for storing song information in a media player, comprising:
means for presetting a list of information in a memory in advance that indicates categories of song information that should be stored or not in a media player;
means for checking whether a user activates a record button or equivalent thereof to instruct that song information of a song that is currently being played from a digital radio broadcasting station should be stored in the media player;
means for retrieving the song information that is a group of information of the song that has been played at the timing of the user's instruction;
means for comparing a category of the song information retrieved with the preset category of song information stored in the memory, thereby determining whether particular song information is necessary; and
means for storing only the song information that is determined to be necessary in the media player while deleting the remaining song information.

12. An apparatus for storing song information in a media player as defined in claim 11, wherein said song information is expressed by meta data which is digital data attached to digital data expressing the song currently broadcasted from the digital radio broadcasting station for explaining the information related to the song.

13. An apparatus for storing song information in a media player as defined in claim 11, wherein said activation of the record button or equivalent thereof is made when the user is listening a song through the digital radio broadcasting to obtain the song information concerning the song.

14. An apparatus for storing song information in a media player as defined in claim 11, further comprising:
means for comparing the song information retrieved upon the instruction by the user with song information already stored in the media player;
means for determining a duplication condition in a case where the both song information are identical to one another; and
means for deleting either one of the song information when there is the duplication condition.

15. An apparatus for storing song information in a media player as defined in claim 11, wherein said means for deleting either one of the song information includes means for discarding the song information newly retrieved in response to the activation of the record button.

16. An apparatus for storing song information in a media player as defined in claim 12, wherein said means for presetting the list of information indicating the categories of song information includes means for specifying an announcement or a time space contained in the meta data of the song as an unnecessary category of meta data.

17. An apparatus for storing song information in a media player as defined in claim 12, further comprising means for selecting the meta data of a first song rather than a second song when the activation of the record button or equivalent thereof is made at a timing of broadcasting transition from the first song to the second song.

18. An apparatus for storing song information in a media player as defined in claim 12, further comprising means for connecting the media player to a network to reach a service provider and sending the meta data of the song to the service provider to download the song data via the network.

19. An apparatus for storing song information in a media player as defined in claim 12, further comprising:
means for connecting the media player to a computer and sending the meta data to the computer;
means for connecting the computer to a network to reach a service provider and sending the meta data of the song to the service provider to download the song data via the network; and
means for sending the downloaded song data from the computer to the media player.

20. An apparatus for storing song information in a media player as defined in claim 12, wherein said song and meta data via the digital radio broadcasting are received by the media player or a receiver installed in a vehicle where an interface device for conducting each of the above defined steps is connected to the media player.
